(19) United States
(12) Patent Application Publication
(10) Pub. No.: US 2021/0400990 A1
(43) Pub. Date: Dec. 30, 2021

(54) 18" Cast iron baking pan with removable bottom and cast iron resting stand and serving trowel

(71) Applicant: Stevie Cheyenne Alexander, Asheville, NC (US)

(72) Inventor: Stevie Cheyenne Alexander, Asheville, NC (US)

(21) Appl. No.: 16/873,751

(22) Filed: Jun. 25, 2020

(51) Int. Cl. A21B 3/13; A47J 37/01; A47J 36/02; A47J 45/06; A47J 36/34; A47J 43/28

(52) U.S. Cl. CPC A21B 3/135; A47J 37/01; A47J 43/288; A47J 45/06; A47J 36/34; A47J 36/02

(57) ABSTRACT

A baking form that has an outer shell with a bottom plate positioned that creates the container, which gives support to the food item to be baked inside. The removable bottom plate allows the food to be separated from the entire baking form. The baking form is part of an entire system, which includes a stand that is used to support and push the entire baked good that sits on the removable plate up and free from the outer shell in order to place the entire content onto a working surface. The baking system also includes a larger serving trowel that is needed to support a larger piece of the baked good from the whole.

### CROSS-REFERENCE TO RELATED APPLICATIONS

none

### STATEMENT REGARDING FEDERALLY SPONSORED RESEARCH OR DEVELOPE

none

### THE NAMES OF THE PARTIES TO A JOINT RESEARCH AGREEMENT

none

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

none

### STATEMENT REGARDING PRIOR DISCLOSURES BY THE INVENTER OR A JOINT INVENTER

none

### BACKGROUND OF THE INVENTION

### (1) Field of the Invention

Skillets

### (2) Description of Related Art Including Information Disclosed Under 37 CFR 1.97 and 1.98

none

### BRIEF SUMMARY OF THE INVENTION

The cast iron baking system assembly relates to a variety of baking trays for cakes, pies and other baked items in whole or to be divided into a plurality of smaller serving sizes that are cut from the whole. The baking system is a tangible idea, a baking container as a method that includes an outer shell rim for supporting an uncooked food item of dough or batter positioned inside and on top of the removable bottom plate. The baking assembly also includes a stand, which is positionable beneath the removable bottom plate inside the outer rim and is proportionally sized to fit through the opening at the bottom of the assembly and supports the entire baked good to be removed from the outer rim of the assembly. The system also includes an extra larger cast iron serving trowel that is sized proportionally to support a piece cut from the baked good as a whole to be removed and placed onto an individual serving plate.

### BRIEF DESCRIPTION OF THE SEVERAL VIEWS OF THE DRAWING(S)

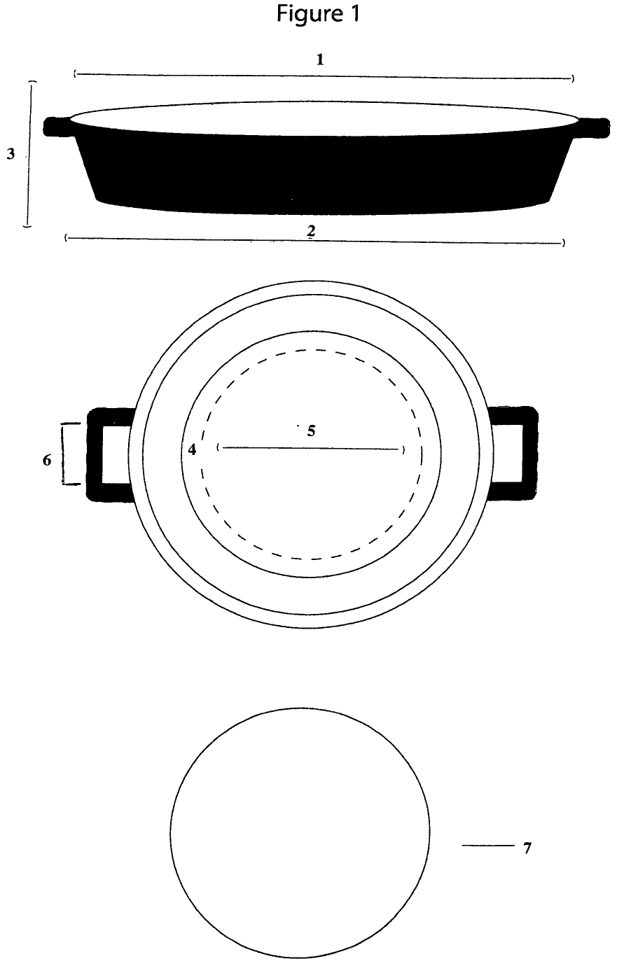

FIG. 1
1. Top view of pan is seventeen inches in diameter across
2. Bottom view of pan is sixteen and half inches in diameter across
3. Side view of pan is two inches high
4. Half inch ledge for removable plate to rest on
5. Sixteen inch opening at the bottom of pan allowing cast iron stand to fit through for removable plate to rest on
6. Two three- and half-inch handle(s) on each side
7. Sixteen and five eight inches in diameter across removable plate

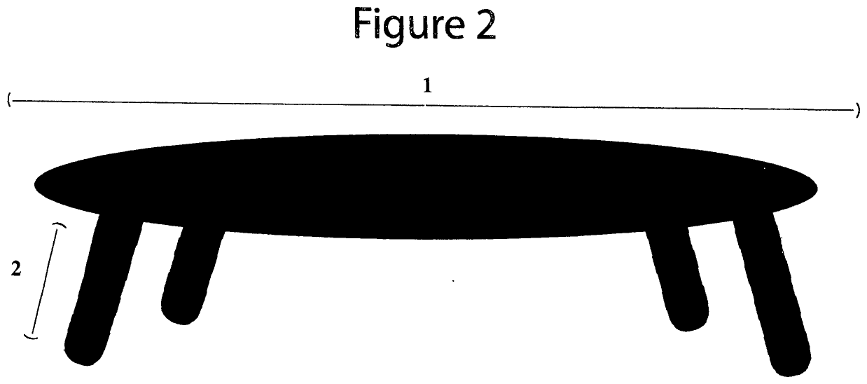

FIG. 2
1. Top view of cast iron stand is fifteen and half inches in diameter across
2. Four two-inch cast-iron leg(s) supporting the cast iron stand

FIG. 3
1. Seven and half inch flat, elongated rectangular shaped surface of cast iron serving trowel
2. Two-inch height of the flat, back part of trowel attached to bottom portion
3. Six-inch length of the flat, back part of the trowel attached to bottom portion
4. Five inch serving handle

### DETAILED DECRIPTION OF THE INVENTION

Before any system assembly of invention is explained, it is to be understood that the invention is not limited in its application to the details of construction and arrangements of set forth in the following description or illustrated in the following drawings. The invention is capable of being used in various ways. It is to be understood that the terminology used herein is used for the description.

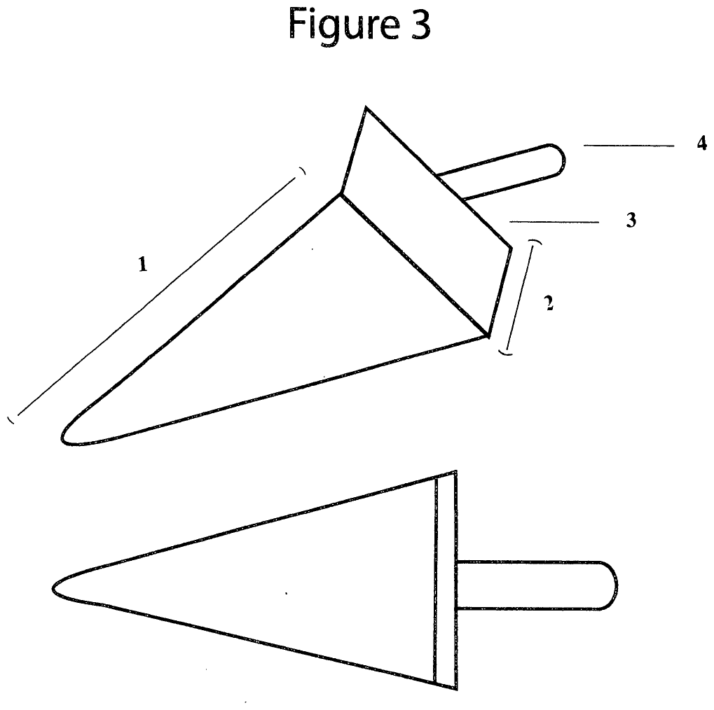

FIGS. 1 illustrates a specialized large baking pan is circular that supports; for example, any cake, pie or casserole. (FIG. 1-1) The baking assembly consists of an open top, seventeen-inch diameter across, which enables dough or other food item to be placed down into the baking pan. (FIG. 1-2) In part of the assembly is the bottom, which is sixteen and half inches in diameter across, which includes a (FIG. 1-4) half inch lip that extends inwardly for the removable plate to sit on. (FIG. 1-3) The outer shell or sidewall is comprised at two inches in height and includes (FIG. 1-6) two three and a half inch open handles that extend outwardly, each located on the top part of the rim positioned on opposite sides of the rim from each other used to grip the entire pan assembly when removing from oven, refrigerator or to a working surface. (FIG. 1-5) The open portal at the bottom of the baking assembly is sixteen inches in diameter across and provides a way for the serving stand (FIG. 2) to fit through for the bottom plate (FIG. 1-7) with the baked good to rest on for removal from the entire baking assembly. The bottom plate (FIG. 1-7) is a flat sheet sixteen and five eight inches in diameter across that is shaped and sized to fit within the (FIG. 1-3) outer shell or side wall. When the plate is positioned on the bottom portion (FIG. 1-2) of the baking assembly and sits on the lip (FIG. 1-4) it covers the open portal at the bottom of the pan completely to the outer wall of the baking pan. The bottom plate is a separate but integral part of the assembly as a whole and allows the baked good to rest on top for easy removal from the outer shell for serving.

FIGS. 2 illustrates the stand to be used with the baking assemble. The illustrated stand comprises of a flat, one-piece solid top (FIG. 2-1) fifteen and a half inches in diameter across, which is sized and shaped enabling the stand to fit through the opening or portal (FIG. 1-5) at the bottom (FIG. 1-2) of the baking assembly. (FIG. 2-2) illustrates the four leg portions attached to the underside of the stand plate (FIG. 2-1), which support the stand as a whole. The legs are located at four equal distances apart from each other. The four legs are two inches in length giving the stand height. When the entire baking assemble with the baked good is lifted up by the two handles (FIG. 1-6) and set onto the serving stand allowing the bottom plate (FIG. 1-7) with the baked good to rest down on top of the stand will then push the entire bottom plate and baked good up free from the outer shell or wall and allow the out shell or wall to sit down on the working counter space. This will give the space needed to lift the entire baked good on the bottom plate and serving stand to be picked up and out from the baking wall of the pan and placed back on a working surface or table.

FIGS. 3 illustrates the large serving trowel to be used with the baking assemble. The illustrated trowel comprises of a flat, elongated rectangular blade having lateral edges and end edges. (FIG. 3-1) illustrates the flat, elongated rectangular blade seven and a half inches in length with a slightly rounded tip end. The flat back portion of the trowel (FIG. 3-2) is two inches in height and the length portion of the back portion of the serving trowel is six inches giving support to the back of the baked good piece to be removed from the baked good as a whole. (FIG. 3-4) The five-inch handle portion of the trowel, which is adjoined to the middle top part of the back portion (FIG. 3-2, 3) of the trowel giving the trowel support to lift and remove a portion or piece of the baked good in its entirety and place it on an individual serving plate.

The entire baking assemble (FIGS. 1, 2, 3) is comprised of cast iron. This gives the assemble the needed support for a very large baked good, along with the solid plate top of the stand. The much larger serving trowel is needed to remove a larger portion of the baked good to be removed without the piece falling apart. All portions of the assembly can be easily cleaned with mild dish soap and warm water. After all portions of the assemble are completely dried, a thin coat of cooking oil can then be applied to all pieces of the assemble and wrapped in plastic to maintain the condition of the assemble before storing away.

What is claimed is:

1-3. (canceled)

4. An all-cast iron baking assembly comprising:
an outer shell or wall;
a bottom plate positioned within the outer shell or wall for support of the baked good or food item, the bottom plate, which is removable from the outer shell or wall;
a stand that can be positioned beneath the removable bottom plate of the cast iron baking assembly, which is sized proportionally to fit through the opening or portal at the bottom of the baking pan and supports the removable plate and food item apart from the outer shell or wall;
a cast iron serving implement or trowel used to support a large piece of baked good or food item to be removed from the large cast iron baking assembly.

5. The cast iron baking assembly of claim 4, wherein the outer shell or wall includes a lower lip, and wherein the bottom plate is supported by the lower lip when positioned within the outer shell or wall.

6. the cast iron baking assembly of claim 4, wherein the stand includes a second portion positioned lower than a first portion relative to a support surface, and wherein the second portion supports the outer shell or wall above the support surface.

7. The cast iron baking assembly of claim 6, wherein the stand supports the bottom plate above the outer shell or wall.

8. A cast iron baking assembly comprising;
an outer shell defining an opening or portal;
a bottom plate positioned within the outer shell and over lying the opening for supporting the baked good or food item, the bottom plate is removable from the outer shell to separate the baked good or food item from the outer shell; and
a stand positionable beneath the bottom plate, the stand including a first portion sized to fit within the opening or portal to support the bottom plate apart from the outer shell.

9. The cast iron baking assembly of claim 8, wherein the outer shell includes a lower lip defining the opening or portal, and wherein the bottom plate is supported by the lower lip when positioned within the outer shell or wall.

10. The cast iron baking assembly of claim 8, wherein the stand includes a second portion to support the outer shell or wall when the first portion of the stand supports the bottom plate apart from the outer shell or wall.

11. The cast iron baking assembly of claim 10, wherein the second portion is positioned lower than the first portion relative to the support surface, and wherein the second portion supports the outer shell or wall between the support surface and the bottom plate.

12. A method of baking a food item in a cast iron baking assembly, the cast iron baking assembly including an outer shell or wall, a bottom plate positioned within the outer shell or wall for supporting the baked good or food item, a stand assembly, the method comprising;
positioning an uncooked food item in a baking assembly;
baking the uncooked food item in the baking assembly to create a cooked food item;
supporting the bottom plate on a first portion of the stand assembly; and separating the outer shell or wall from the bottom plate to remove the baked good or food item from the outer wall.

13. The method of claim 12, wherein the outer shell or wall defines an opening and the stand includes the first portion, and wherein separating the outer shell or wall from the bottom plate includes extending the first portion of the stand through the opening or portal to support the bottom plate apart from the outer shell or wall with the stand.

14. The method of claim 13, wherein the stand includes a second portion that engages a support surface, the method further comprising supporting the outer shell or wall of the cast iron baking assembly above the support surface and on the second portion when the first portion supports the bottom plate apart from the outer shell or wall.

15. The method of claim 14, wherein supporting the outer shell or wall of the cast iron baking assembly above the support surface includes supporting the outer shell or wall below the bottom plate.

16. The cast iron serving implement of claim 4 comprising:
a flat, extra-large elongated rectangular element six to seven inches in length with opposing ends;
a handle extending from one of the opposing ends of the elongated element in a first direction and at a substantially right angle relative to the elongate element; and
a head extending away from the other of the opposing ends in a second direction opposite the first direction and at a substantially right angle relative to the elongate element and terminating with an outer end;
the head having an elongated rectangular plate or face with a slight round point for receiving or holding a larger piece of baked good or food item that is flat substantially from the opposing ends of the elongate element to the outer end.
